(19) United States
(12) Patent Application Publication
(10) Pub. No.: US 2013/0183126 A1
(43) Pub. Date: Jul. 18, 2013

(54) Flatbed truck method with a pickup truck

(71) Applicant: Larry Alexander, Indianapolis, IN (US)

(72) Inventor: Larry Alexander, Indianapolis, IN (US)

(21) Appl. No.: 13/374,766

(22) Filed: Jan. 13, 2012

(51) Int. Cl. B60P 1/04; B23P 17/04

(52) U.S. Cl. 414/542; 29/401.1

(57) ABSTRACT

A specially designed crane, lift or hoist is utilized in converting a pickup truck into a flatbed type of vehicle. The crane is specially built in that it may fold down into a horizontal position wherein the drive and driven portions of the crane are parallel to each other in the rest position. A first crane WL1 is fastened to the pickup truck bed. A flatbed-type of plate 40 is attached to the top of the first crane. The plate 40 is of sufficient elongation to provide cover and protection for cargo units on the pickup truck bed. On top of the plate 40, a second crane WL2 may be mounted and utilized to move a second group of cargo units. Thus, the cranes are in a novel stacked configuration to load and unload more and more varied types of cargo.

### BACKGROUND AND OBJECTS OF THE INVENTION

The present invention is generally related to the product transportation and loading/unloading arts pertaining to the specialized use of a crane, lift or hoist device known as a Weightlifter. “Weightlifter” is a trademark of the applicant named herein.

As will be further described, the Weightlifter is a type of crane or lift which can be folded into a flat position which is a highly useful function for loading and unloading systems and methods of transport.

The Weightlifter itself has been shown as element number 10 in applicant's prior patents which will be listed herein.

It is an object of the present invention to utilize the Weightlifter in a new and highly useful method to modify a pickup truck. The Weightlifter and combined cargo are placed in the back bed of a pickup truck.

Subsequently, a special flat bed plate is added to the top of the Weightlifter to enable the pickup truck to function in a dumping mode as desired.

The use of the added special flat bed plate also serves to secure the cargo space of the vehicle so that valuable product items are protected from theft or vandalism.

The special flat bed plate may be lifted onto the Weightlifter or pulled onto the Weightlifter via suitable winch means.

The special flat bed plate could also have a second Weightlifter WL2 mounted on top thereof, with suitable secondary cargo, to provide a stacked crane or lift configuration which is novel and highly advantageous in the delivery arts.

These and other objects and advantages of the present invention will be apparent to those of skill in the art from the description which follows.

### PRIOR ART PATENTS AND DESIGNS

The prior art U.S. Patents related to the present invention are listed as follows: (all are issued to the present inventor, Larry Alexander)
U.S. Pat. No. 7,815,411 for a landscaping method using the Weightlifter in combination with a dump box,
U.S. Pat. No. 7,717,662 for a utility truck having a Weightlifter nestled in the back thereof to protect the crane from severe weather elements,
U.S. Pat. No. 7,713,019 for a standard flat-bed truck having Weightlifter cranes mounted thereon.

The present invention is submitted to be clearly patentable over the above and all known prior art patents and designs.

### BRIEF DESCRIPTION OF THE DRAWING FIGURES

FIG. 1 shows a crane, lift or hoist unit which has been specially designed by applicant and which has a number of critical uses. As shown in FIG. 1a, the crane is foldable to a horizontal position with the drive arms and the driven arms in parallel to each other. The driven arms 11, 12 and 14 (FIG. 1c) are movable through various angles as shown in FIGS. 1a-1f.

FIG. 2 shows the crane 10 or WL1 mounted to the bed of a pickup truck via fasteners 31 and 31a. A flatbed-type plate 40 is mounted to the top of crane 10 via fasteners 41 and 42 after being lifted via handle 46. The plate 40 is elongated enough that it serves to protect plural cargo units indicated at C1 and C2.

FIG. 3 shows a second crane WL2 of the type 10 shown in FIG. 1. This second crane WL2 is mounted on top of flatbed-type plate 40 via fasteners 43 and 44. Cargo units C3 and C4 are shown on top of plate 40.

FIG. 4 shows, in block diagram form, the method steps used in practice of the invention.

### FULL DESCRIPTION OF A PREFERRED EMBODIMENT

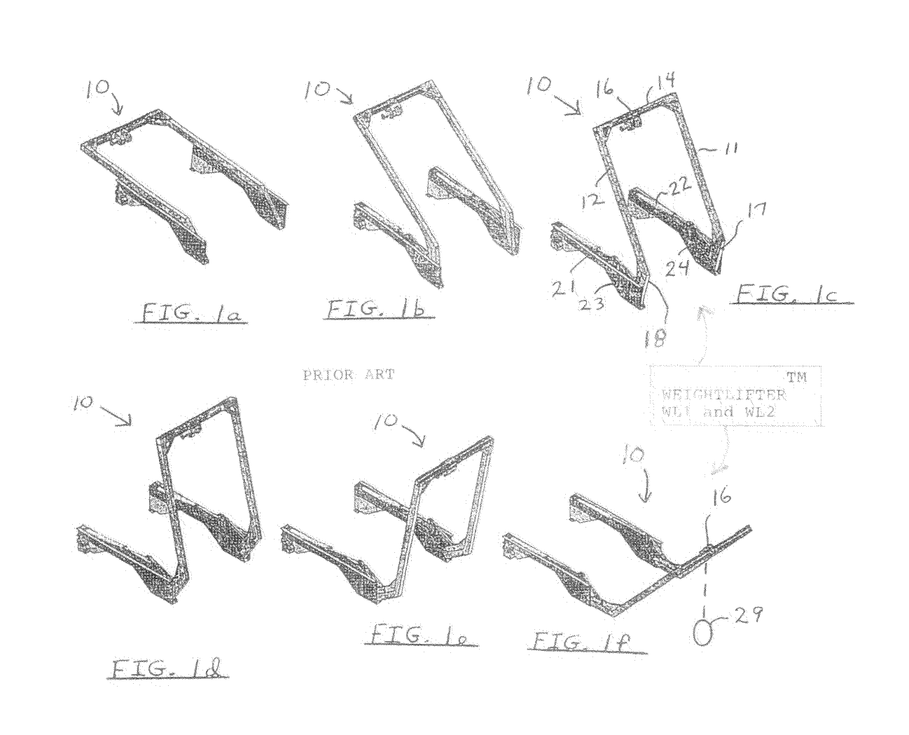

Referring to the drawing FIG. 1, there is shown a crane, lift or hoist unit, known by the trademark “Weightlifter”, which starts in a horizontal position shown in FIG. 1a.

The upper, driven part of the crane 10, comprising arms 11, 12 and cross-bar 14 (having a winch 16 thereon), is driven from the horizontal position of zero degrees through various angles to a load 29 releasing angle of about 135°.

The lower drive portion, comprising portions 21-24, remains in a lower horizontal position.

Such elements and operations are shown in applicant's own prior art patents.

The numbers of such patents are listed within this specification.

Described herein is a novel use for the above crane or Weightlifter 10 which is shown and indicated herein as WL1 and WL2, being lower and upper cranes respectively.

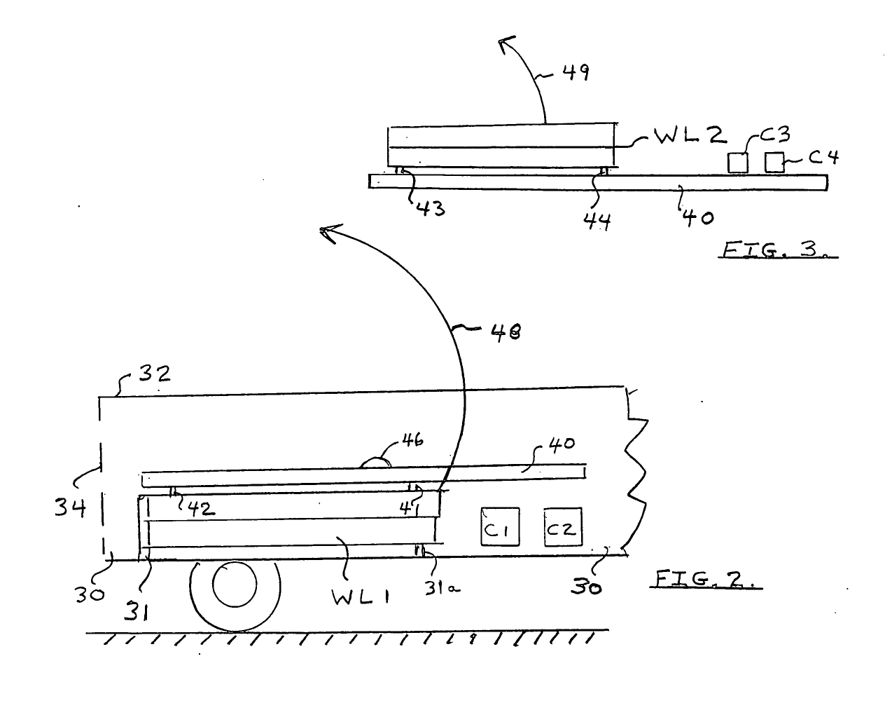

Referring to the drawing FIG. 2, a pickup truck bed 30 is shown as having a lower floor portion, a rear tailgate portion 34 and side wall means 32.

A crane or lift WL1 (for Weightlifter no. 1), is secured to the pickup truck bed by fasteners 31 and 31a. The upper part of crane WL1 moves from the zero degree angle shown to a 135° angle as indicated by arrow 48.

Also on the pickup truck bed are shown plural cargo units C1 and C2. Such would normally be unloaded as desired via the crane WL1.

In a novel aspect of the invention, a special flat bed plate 40 is added to the top of the crane WL1 via fasteners 41 and 42.

The flat bed plate 40 provides two important and critical functions: first, it protects the cargo elements C1 and C2 from damage or theft. Second, the upper plate 40 can be used as a dump box for soil etc. when it is rotated as indicated by arrow 48.

The flat plate 40 may be lifted or pulled onto the crane WL1 via a reinforced eyelet 46.

FIG. 3 shows another important and critical aspect of the invention which is achieved via the addition of the special flat bed plate 40.

As shown in FIG. 3, a second crane or lift WL2 is added the the system by mounting it to the flat bed plate 40.

Such is achieved via fasteners 43 and 44.

Cargo elements C3 and C4 are also able to be placed on top of the flat plate to provide for additional product transport as required.

Cargo units C3 and C4 may be unloaded via the upper crane WL2 when its upper portion is rotated as indicated by arrow 49.

Thus, the special flat bed plate 40 allows a stacked crane configuration for the delivery of more products and a more diverse group of products.

Such a multiple or stacked crane usage is thus critical and is enabled via the flat bed plate 40.

The primary method steps used in practice of the invention are listed below.

The first method step comprises placing a crane unit WL1 and cargo on to the bed of a pickup truck.

Method step 2 is the addition of the special flat bed plate 40 to the top of the crane WL1.

Further steps may include the addition of a second or stacked crane WL2 to the top of the flat bed plate 40 along with cargo units C3 and C4.

The fasteners schematically shown are of a quick connect type known in the mechanical arts.

While a particular system and method have been shown, it is intended in this specification to broadly cover all equivalent systems and methods which would reasonably occur to those of skill in the art.

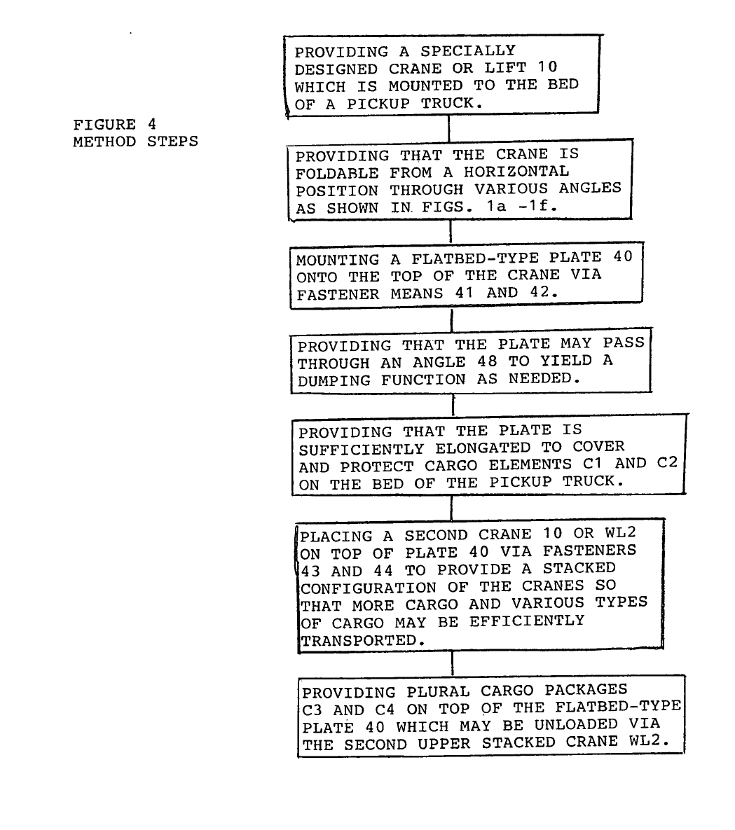

FIG. 4 shows important and critical METHOD STEPS utilized in practice of the invention.

I claim:

1. In combination with a bed of a pickup truck, a first crane or lift (WL1) having a lower and stationary portion and an upper rotatable portion,
cargo means (C1 and C2) positioned to be unloaded via the first crane means (WL1),
a special flat bed plate (40) being mounted to the lift or crane (WL1),
a second crane or lift (WL2) being mounted to the top of the flat bed plate (40) to provide means whereby the cranes are stacked to provide a larger product quantity to be delivered.

2. The combination of claim 1 wherein the plate (40) is of sufficient elongation to cover and protect said cargo means (C1,C2).

3. The combination of claim 2 wherein the plate (40) has handle means (46) on top thereof and wherein the plate (40) has cargo units (C3,C4) positioned on top thereof.

4. A method of converting a pickup truck into a flatbed truck type of vehicle comprising the steps of:
a) attaching a first crane to the bed of a pickup truck, wherein the first crane has drive and driven portions which are positionable to lie in parallel to each other,
b) providing that cargo units are positioned on the bed of the pickup truck,
c) attaching a flat plate (40) to the top of the first crane and providing means whereby the flat plate may be rotated and further providing that the flat plate be of sufficient elongation to provide cover or protection for the cargo units,
d) providing that the flat plate have handle means on top thereof for loading and unloading the flat plate onto the top of the first crane,
e) attaching a second crane to the top of said flat plate to provide means for unloading and loading a second group of cargo units (C3, C4).

5. A method of converting a pickup truck into a flatbed truck type of vehicle comprising the steps of:
a) attaching a first crane (WL1) to the bed of a pickup truck, wherein the first crane has drive and driven portion means positionable to lie in parallel to each other,
b) providing that cargo units (C1,C2) are placed on the bed of the pickup truck,
c) attaching a flat plate (40) to the top of the first crane and providing means whereby the flat plate may be rotated and further providing that the flat plate be of sufficient elongation to provide cover or protection for the cargo units.

6. The method of claim 5 and further including the step of:
attaching a second crane (WL2) to the top of the flat plate (40),
wherein the first and second cranes form a stacked configuration means for loading and unloading more and varied cargo (C1,C2,C3,C4).
